(19) United States
(12) Patent Application Publication
(10) Pub. No.: US 2024/0062350 A1
(43) Pub. Date: Feb. 22, 2024

(54) DISTANCE IMAGE SENSOR DEVICE, DISTANCE IMAGE PROCESSING SYSTEM, AND TRANSMISSION METHOD OF DISTANCE DATA

(71) Applicant: Sony Semiconductor Solutions Corporation, Kanagawa (JP)

(72) Inventor: Goshi Watanabe, Saitama (JP)

(21) Appl. No.: 18/260,712

(22) PCT Filed: Jan. 14, 2022
(86) PCT No.: PCT/JP2022/001096

§ 371 Date: Jul. 7, 2023

(30) Foreign Application Priority Data
Feb. 25, 2021 (JP) 2021-028538

(51) Int. Cl. G06T 5/00; G06T 5/40; G06V 10/141; G06V 10/25; G06V 10/56; G06V 10/74; G06V 10/764

(52) U.S. Cl. CPC G06T 5/009; G06T 5/40; G06V 10/141; G06V 10/25; G06V 10/56; G06V 10/761; G06V 10/764; G06T 2207/10024

(57) ABSTRACT

Distance image sensing is disclosed. In one example, a sensing device includes distance measurement processing that calculates a distance to an object in the target area on the basis of the electric signal output from each of a plurality of light receiving pixels and outputs distance data based on the distance. The sensing device also performs gamma correction on the output distance data by applying a gamma curve profile indicated by operation conditions corresponding to a predetermined distance measurement range, and transmits the gamma-corrected distance data to a host device.

### TECHNICAL FIELD

The present invention relates to a distance image sensor device, a distance image processing system, and a transmission method of distance data between the distance image sensor device and a host device in the distance image processing system.

### BACKGROUND ART

A distance image sensor device (also referred to as a distance measurement sensor in some cases) that measures the distance to an object (body or subject) on the basis of ToF (Time of Flight) has been known. In general, there are direct ToF and indirect ToF in ToF. The direct ToF is a technique in which pulse light is emitted from a light emitting element, reflected light from an object to which the pulse light is applied is received by a light receiving element called SPAD (Single Photon Avalanche Diode) arranged in an array to detect photons, carriers generated thus are converted into an electric signal by using avalanche multiplication, the electric signal is input to a TDC (Time to Digital Converter) to measure the arrival time of the reflected light, and the distance to the object is calculated. On the other hand, in the indirect ToF, pulse light is emitted from a light emitting element, electric charges generated by receiving reflected light from an object to which the pulse light is applied by a light receiving element, the time of flight of the light is measured by using a semiconductor element structure in which the accumulated amount of the electric charges changes depending on the arrival timing of the light, and the distance to the object is calculated.

Data related to the distance for each light receiving element calculated by a distance image sensor device is transmitted to an external host device via a predetermined communication line according to a predetermined data format, and the host device generates a two-dimensional distance image frame on the basis of the received distance data. By increasing the bit length of the payload in the data format when communicating between the distance image sensor device and the host device, high-quality distance images with high distance measurement accuracy and/or a wide dynamic range can be secured, but the required amount of data transmission bandwidths is increased, resulting in higher hardware costs.

In order to realize both the image quality and the data transmission efficiency described above, it is effective to efficiently compress or quantize transmission data. For example, PTL 1 described below discloses a technique for realizing dynamic range compression that takes advantage of the color reproduction ability of an output device while requiring less computation load in a case where scene reference image data is converted into image data for the output device. Specifically, PTL 1 described below discloses a technique for analyzing the color distribution of scRGB image data, setting range compression conditions for tone mapping processing, compressing a dynamic range on the basis of the range compression conditions, converting the scRGB image data into a range that can be represented in the extended RGB color space, and converting a color signal compressed to the dynamic range of extended RGB into a CMYK signal that is a printer output signal.

### CITATION LIST

### Patent Literature

### [PTL 1]

Japanese Patent Laid-open No. 2008-72551

### SUMMARY

### Technical Problems

The technique disclosed in PTL 1 described above relates to the compression of the dynamic range by the tone mapping processing in the RGB color image data of what is called a Viewing system, and is considered to function in image processing in pursuit of visual effects (appearance) over the entire image.

On the other hand, in imaging (distance measurement) by the distance image sensor device, there are many cases in which the distance to an object and the region occupied by the object relative to the region of the entire distance image have low relevance. For example, in the imaging of a person with an outdoor landscape as a background, unlike the Viewing system in which the landscape that occupies most of the entire image is emphasized together with the person in the composition of the imaging frame, there are many cases in which only the person who is the target of distance measurement is emphasized. Thus, even if the technique disclosed in PTL 1 is directly applied to the distance image sensor device, both the image quality and the data transmission efficiency could not be realized. Further, with the miniaturization of the semiconductor manufacturing technique, the amount of distance data obtained from the distance image sensor device is also increased, and the limitation of the amount of data transmission bandwidths becomes a bottleneck in the system processing performance.

Therefore, an object of the present disclosure is to provide a technique that can realize both the quality of a distance image and the data transmission efficiency in a distance image processing system.

More specifically, an object of the present disclosure is to provide a distance image processing system that can efficiently transmit distance data from a distance image sensor device to a host device so that the quality of a distance image is not deteriorated under the limitation of the amount of data transmission bandwidths between the distance image sensor device and the host device.

### Solution to Problems

In order to solve the above problems, the present invention includes the following specific matters of the invention or technical features.

According to a point of view, the present technique is a distance image sensor device that operates according to operation conditions adapted to a predetermined distance measurement range. The distance image sensor device includes an operation condition setting unit for setting operation conditions including a frequency and a gamma curve profile adapted to a predetermined distance measurement range, a light emitting unit that emits pulse light to a target area at the frequency under the set operation conditions, a light receiving unit that includes a plurality of light receiving pixels for receiving observation light in the target area in response to the pulse light and each outputting an electric signal according to an electric charge accumulated by photoelectric conversion, a distance measurement processing unit that calculates a distance to an object in the target area on the basis of the electric signal output from each of the plurality of light receiving pixels and outputs distance data based on the distance, a gamma correction unit that performs gamma correction on the output distance data by applying the gamma curve profile in the set operation conditions, and a communication interface unit that transmits the gamma-corrected distance data to a host device.

In addition, according to another point of view, the present technique is a distance image processing system including a distance image device and a host device connected to the distance image device via a communication line. The distance image device includes an operation condition setting unit for setting operation conditions including a frequency and a gamma curve profile adapted to a predetermined distance measurement range, a light emitting unit that emits pulse light to a target area at the frequency under the set operation conditions, a light receiving unit that includes a plurality of light receiving pixels for receiving observation light in the target area in response to the pulse light and each outputting an electric signal according to an electric charge accumulated by photoelectric conversion, a distance measurement processing unit that calculates a distance to an object in the target area on the basis of the electric signal output from each of the plurality of light receiving pixels and outputs distance data based on the distance, a gamma correction unit that performs gamma correction on the output distance data by applying the gamma curve profile in the set operation conditions, and a communication interface unit that transmits the gamma-corrected distance data to a host device via the communication line. In addition, the host device includes a gamma correction unit that performs inverse gamma correction on the distance data received via the communication line by applying an inverse gamma curve profile corresponding to the gamma curve profile in the operation conditions.

Further, according to still another point of view, the present technique is a transmission method of distance data between a distance image device and a host device in a distance image processing system. In the transmission method, the distance image device executes setting operation conditions including a frequency and a gamma curve profile adapted to a predetermined distance measurement range, emitting pulse light to a target area at the frequency under the set operation conditions, receiving observation light in the target area in response to the pulse light and outputting an electric signal according to an electric charge accumulated by photoelectric conversion from each of a plurality of light receiving pixels, calculating a distance to an object in the target area on the basis of the electric signal output from each of the plurality of light receiving pixels and outputting distance data based on the distance, performing gamma correction on the output distance data by applying the gamma curve profile in the set operation conditions, and transmitting the gamma-corrected distance data to the host device via a communication line.

It should be noted that, in this specification and the like, means does not simply mean physical means, but also includes a case in which the function of the means is realized by software. In addition, the function of one piece of means may be realized by two or more pieces of physical means, or the functions of two or more pieces of means may be realized by one piece of physical means. In addition, a “system” is a logical collection of a plurality of devices (or functional modules that realize a specific function), regardless of whether or not each device or functional module is contained within a single housing.

### Advantageous Effects of Invention

Other technical features, objects, and working effects, or advantages of the present technique will become apparent by the following embodiments to be described with reference to the attached drawings. The effects described in the present disclosure are only illustrative and not limited, and may have other effects.

### BRIEF DESCRIPTION OF DRAWINGS

FIG. 1 is a block diagram for depicting an example of a schematic configuration of a distance image processing system according to a first embodiment of the present technique.

FIG. 2 is a block diagram for depicting an example of a configuration of the distance image processing system according to one embodiment of the present technique.

FIG. 3 includes diagrams each depicting an example of a gamma curve profile in the distance image processing system according to one embodiment of the present technique.

FIG. 4 is a flowchart for explaining an operation in the distance image processing system according to one embodiment of the present invention.

FIG. 5 is a block diagram for depicting an example of a configuration of a distance image processing system according to a second embodiment of the present technique.

FIG. 6 is a block diagram for depicting an example of a configuration of a distance image processing system according to a third embodiment of the present technique.

FIG. 7 is a block diagram for depicting an example of a configuration of a distance image processing system according to a fourth embodiment of the present technique.

FIG. 8 is a block diagram for depicting an example of a configuration of a distance image processing system according to a fifth embodiment of the present technique.

FIG. 9 is a diagram for explaining an example of a histogram in the distance image processing system according to one embodiment of the present technique.

FIG. 10 is a block diagram for depicting an example of a configuration of the distance image processing system according to one embodiment of the present technique.

FIG. 11 is a diagram for explaining an example of a distance classification map in the distance image processing system according to one embodiment of the present technique.

### DESCRIPTION OF EMBODIMENTS

Hereinafter, embodiments of the present invention will be described with reference to the drawings. However, the embodiments to be described below are illustrative only and are not intended to exclude the application of various modifications and techniques that are not specified below. The present invention can be carried out by various modifications (for example, by combining the respective embodiments, and the like) in the range without deviating from the scope thereof. In addition, in the description of the drawings below, the same or similar parts are denoted by the same or similar reference signs. The drawings are schematic and do not necessarily match actual dimensions, ratios, and the like. Even among the drawings, there may be parts having a different relation between dimensions and different ratios.

### First Embodiment

The present embodiment is characterized in that, in a distance image processing system including a distance image sensor device and a host device, it is characterized that distance data generated by the distance image sensor device is gamma-corrected using a gamma curve adapted to a predetermined distance measurement range and that the corrected distance data is transmitted to the host device. In addition, the host device performs inverse gamma correction on the corrected distance data using an inverse gamma curve.

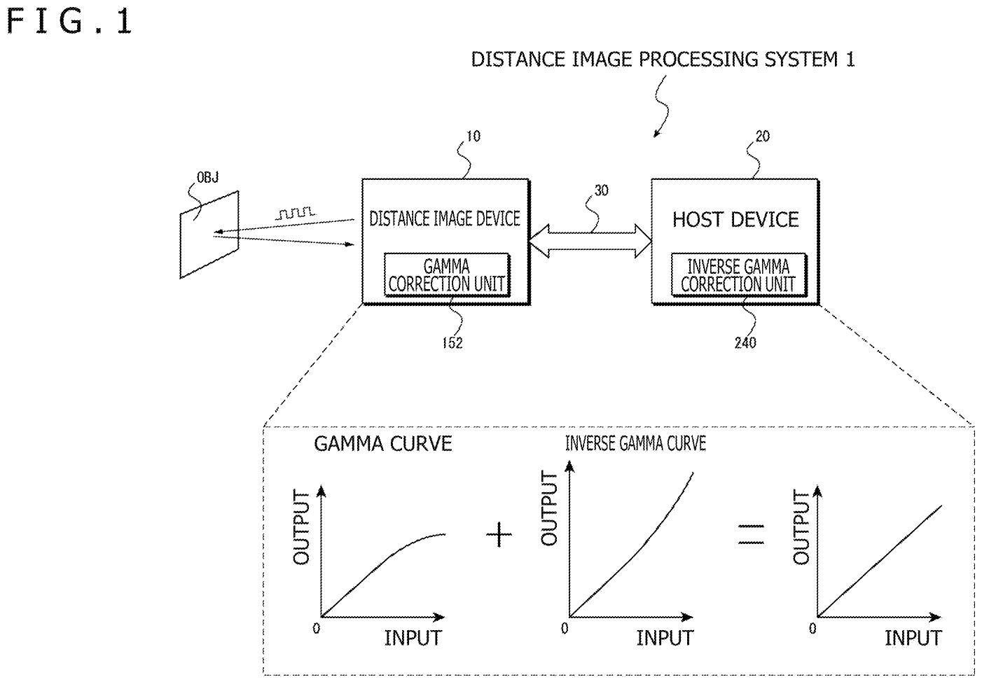

FIG. 1 is a block diagram for depicting an example of a schematic configuration of a distance image processing system according to a first embodiment of the present technique. As depicted in the drawing, a distance image processing system 1 according to the present technique includes a distance image sensor device 10 and a host device 20. The distance image sensor device 10 and the host device 20 are communicably connected to each other via a communication line 30 in accordance with, for example, the MIPI (Mobile Industry Processor Interface) standard.

The distance image sensor device 10 is an active distance measurement sensor for measuring the distance to an object OBJ under the control of the host device 20. That is, the distance image sensor device 10 emits pulse light adapted to a predetermined distance measurement range from a light source, and calculates the distance to the object OBJ on the basis of an electric signal generated by receiving reflected light from the object OBJ, to which the pulse light is applied, with light receiving pixels (light receiving elements) arranged in an array. Therefore, a two-dimensional distance image frame is obtained by calculating the distances for the whole of the light receiving pixels arranged in an array. In the present disclosure, the distance image sensor device 10 is what is called an indirect TOF-type distance measurement sensor, but is not limited to this and may be a direct TOF-type distance measurement sensor. The distance image sensor device 10 transmits data (hereinafter, referred to as “distance data”) based on the distance calculated for each light receiving pixel to the host device 20 via the communication line 30. Here, the distance data is RAW data having linearity in the distance calculated as an output relative to the reach distance of the pulse light as an input.

The host device 20 is a computing device that is positioned as a higher-level device of the distance image sensor device 10, controls the operation of the distance image sensor device 10, and performs image processing on the basis of the distance data transmitted from the distance image sensor device 10. The host device 20 can be, but is not limited to, for example, an imaging camera body or a control circuit incorporated thereinto. As another example, the host device 20 can be what is called an “application” by which desired functions are realized by executing application programs on a computing device such as a smartphone. In such a case, the distance image sensor device 10 can be built into a smartphone as a built-in distance measurement camera.

In this example, the host device 20 sets predetermined operation conditions for the distance image sensor device 10, and the distance image sensor device 10 accordingly operates according to the set operation conditions. The operation conditions include, for example, the frequency of pulse light. The frequency of the pulse light defines the distance measurement range (that is, the effective measurement distance from the light source to the object) of the distance image sensor device 10. In general, for example, in a case where pulse light with a frequency of 100 MHz is used, the distance measurement range is approximately 1.5 m, and in a case where pulse light with a frequency of 20 MHz is used, the distance measurement range is approximately 7.5 m. In a case where the bit lengths of the distance data are the same, the image depth (image quality) becomes finer if the distance measurement range is close and becomes rougher if it is far. For example, the host device 20 can select the frequency of the pulse light according to a desired distance measurement range. In addition, in the present disclosure, the operation conditions include a profile (hereafter, referred to as “gamma curve profile”) depicting a predetermined gamma curve adapted to a predetermined distance measurement range. The gamma curve profile has a data structure in the look-up table format. Alternatively, the gamma curve profile is defined by an approximate curve function. For example, the host device 20 selects a gamma curve profile adapted to the selected frequency (distance measurement range) among several kinds of gamma curve profiles that are defined in advance. As a concrete example, the host device 20 as an application for performing face authentication selects a frequency for a short distance (that is, high frequency) and a gamma curve profile corresponding thereto. Alternatively, the host device 20 as an application for imaging a wide target area selects a frequency for a long distance (that is, low frequency) and a gamma curve profile corresponding thereto.

As will be clarified below, in the distance image processing system 1, the distance image sensor device 10 allows a gamma correction unit 152 to perform gamma correction on the distance data having linearity by using a gamma curve adapted to a predetermined distance measurement range, and transmits the gamma-corrected distance data to the host device 20 via the communication line 30. The host device 20 restores the linearity of the original distance data by allowing an inverse gamma correction unit 240 to perform inverse gamma correction on the received gamma-corrected distance data by using an inverse gamma curve, and performs desired image processing. As described above, the distance data transmitted on the communication line 30 can be efficiently quantized by applying the gamma curve, and the data transmission efficiency can be accordingly improved without significantly deteriorating the image quality.

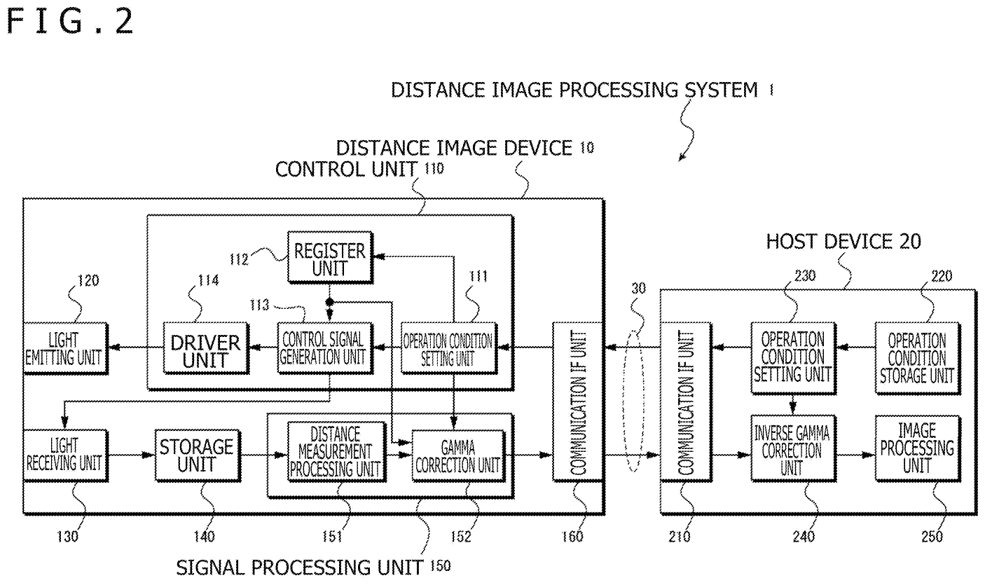

FIG. 2 is a block diagram for depicting an example of a configuration of the distance image processing system according to one embodiment of the present technique. That is, the drawing depicts an example of functional configurations of the distance image sensor device 10 and the host device 20 depicted in FIG. 1.

As depicted in the drawing, the distance image sensor device 10 schematically includes, for example, components such as a control unit 110, a light emitting unit 120, a light receiving unit 130, a storage unit 140, a signal processing unit 150, and a communication interface unit 160. These components can be integrally configured as, for example, a system-on-chip (SoC) such as a CMOS LSI, but are not limited to this, and some components such as, for example, the light emitting unit 120 and the light receiving unit 130 may be configured as separate LSIs.

The control unit 110 comprehensively controls the operation of the distance image sensor device 10. In this example, the control unit 110 includes an operation condition setting unit 111, a register unit 112, a control signal generation unit 113, and a driver unit 114.

The operation condition setting unit 111 stores operation conditions given from the host device 20 via the communication line 30 in the register unit 112. Accordingly, the distance image sensor device 10 can operate according to the operation conditions stored in the register unit 112. As described above, the operation conditions include the frequency of the pulse light and the gamma curve profile. It should be noted that, since the distance measurement range and the frequency of the pulse light are uniquely associated with each other, the operation conditions may be a combination of the distance measurement range and the gamma curve profile. The frequency of the pulse light stored in the register unit 112 is referred to by the control signal generation unit 113, and the gamma curve profile is referred to by the gamma correction unit 152.

The register unit 112 includes at least one register capable of storing various operation conditions. As will be described in the other embodiments, the register unit 112 may include a plurality of registers, each storing different operation conditions. Alternatively, the register unit 112 may store the operation conditions in advance instead of storing the operation conditions given from the host device 20, or may store the operation conditions generated in the distance image sensor device 10. In addition, the register unit 112 may be configured as a part of the control signal generation unit 113 and/or the gamma correction unit 152.

The control signal generation unit 113 generates various control signals according to the operation conditions stored in the register unit 112. For example, the control signal generation unit 113 generates a light emission control signal used for the light emitting unit 120 to emit and scan pulse light with a predetermined frequency indicated by the operation conditions at a predetermined light emission timing, outputs the signal to the driver unit 114, generates a light reception control signal for reading an electric signal from a specific group of light receiving pixels of the light receiving unit 130 at the reading timing corresponding to the light emission timing, and outputs the signal to the light receiving unit 130.

On the basis of the light emission control signal output from the control signal generation unit 113, the driver unit 114 drives the light emitting unit 120 so that the pulse light is emitted at a predetermined frequency, and also drives a light emission optical system (not illustrated) to scan the emitted pulse light in a predetermined direction. For example, the driver unit 114 drives the light emitting unit 120 to repeatedly emit multi-phase (for example, four-phase) pulse light a plurality of times (for example, several thousand times) according to the light emission control signal.

The light emitting unit 120 is a light emitting element that scans a target area while emitting the pulse light with a predetermined frequency for TOF distance measurement. The light emitting unit 120 can include, for example, a light source and an irradiation optical system (not illustrated). The light source can be, for example, a vertical cavity surface emitting laser (VCSEL laser). The light emitting unit 120 is driven at high speeds at a frequency of, for example, 10 to 200 MHz. In addition, the pulse light can have a pulse width of, for example, several to several tens of ns. The light emitting optical system includes, for example, a MEMS scanning mirror, a cylindrical lens, and the like. The light emitting unit 120 spatially emits the pulse light to the target area by, for example, scanning line-shaped light emitted from the light source along one direction (for example, horizontal direction) stepwise in the other direction (for example, vertical direction) perpendicular to the one direction by using a scanning mirror or the like under the control of the driver unit 114. In this example, the light source that emits the line-shaped light is used, but is not limited to this, and a point light source may be used, and in this case, surface emission is realized by two-dimensional scanning. The emission and scanning of such pulse light are performed a plurality of times in one distance measurement (acquisition of one distance image frame) in order to suppress variations in a distance measurement error.

The light receiving unit 130 is a photosensor that responds to light (observation light) entering from the target area, accumulates electric charges under the control of the control unit 110, and outputs an electric signal according thereto. Although not illustrated, a light receiving optical system such as a condenser lens is typically provided in front of the light receiving surface of the light receiving unit 130 so that light can be efficiently received. The light receiving unit 130 is typically a CMOS image sensor including a plurality of light receiving pixels arranged in a two-dimensional array, but is not limited to this, and may be a CCD image sensor. A group of light receiving pixels in each zone of the light receiving unit 130 operates at, for example, a predetermined light reception timing synchronized with a predetermined light emission timing under the control of the control unit 110, and accumulates electric charges according to the incident observation light. More specifically, each light receiving pixel has a pair of gates, the gates are alternately opened by alternately applying a pulse-like gate signal to each of the pair of gates, and each of generated first electric charge and second electric charge is transferred to an electric charge accumulation unit. The first electric charge and the second electric charge accumulated in the electric charge accumulation unit of each light receiving pixel are converted into the amount of change in voltage and read to the outside as an electric signal. For each zone, the light receiving unit 130 accumulates and outputs (reads) the electric charges four times corresponding to, for example, each emission of four-phase pulse light.

The storage unit 140 is a buffer memory that temporarily holds the electric signal read from the light receiving unit 130. The storage unit 140 may be a volatile memory or a nonvolatile memory. In this example, the storage unit 140 is configured to hold electric signals for one frame read from the light receiving unit 130, but is not limited to this. As another example, the storage unit 140 can hold electric signals based on the observation light corresponding to the emission of pulse light for several lines by the light emitting unit 120.

The signal processing unit 150 processes the electric signal held in the storage unit 140 to calculate the distance to the object OBJ. The signal processing unit 150 typically includes a signal processing processor. In the drawing, an example in which the signal processing unit 150 includes the distance measurement processing unit 151 and the gamma correction unit 152 is depicted.

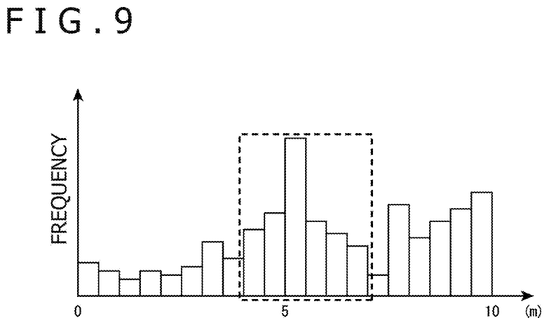

The distance measurement processing unit 151 calculates the distance to the object OBJ on the basis of the electric signals sequentially read from the storage unit 140. Specifically, each time the emission pulse is emitted by the light emitting unit 120, the distance measurement processing unit 151 calculates the distance for each light receiving pixel from the electric signal read from the storage unit 140, and creates a histogram in which the distance is accumulated for each sampling distance (bin) (see FIG. 9). The number of histograms created corresponds to the number of light receiving pixels. Subsequently, the distance measurement processing unit 151 detects the peak value of each created histogram and generates distance data on the basis of the detected peak value. The distance data is RAW data having distance (depth) information of, for example, 256 bits and having linearity in the distance calculated as an output relative to the reach distance of the pulse light as an input. Then, the distance measurement processing unit 151 outputs a series of distance data calculated for each light receiving pixel to the gamma correction unit 152.

The gamma correction unit 152 performs gamma correction on the distance data output from the distance measurement processing unit 151 by applying the gamma curve profile stored in the register unit 112. That is, the distance data having linearity obtained by the distance measurement processing unit 151 is converted into quantized data (gamma-corrected distance data) along the gamma curve profile by the gamma correction. The gamma correction unit 152 outputs the gamma-corrected distance data to the host device 20 via the communication interface unit 160.

The communication interface unit 160 is an interface circuit for communicating with the host device 20. The communication interface unit 160 is an interface circuit conforming to, for example, MIPI (Mobile Industry Processor Interface), but is not limited to this. For example, the communication interface unit 160 may be SPI (Serial Peripheral Interface), LVDS, SLVS-EC, or the like.

As described above, the host device 20 is a device positioned at a higher level of the distance image sensor device 10. As depicted in the drawing, the host device 20 includes, for example, a communication interface unit 210, an operation condition storage unit 220, an operation condition setting unit 230, an inverse gamma correction unit 240, and an image processing unit 250.

The communication interface unit 210 is an interface circuit for communicating with the communication interface unit 160 of the distance image sensor device 10. The communication interface unit 210 can have a configuration similar to that of the communication interface unit 160 described above.

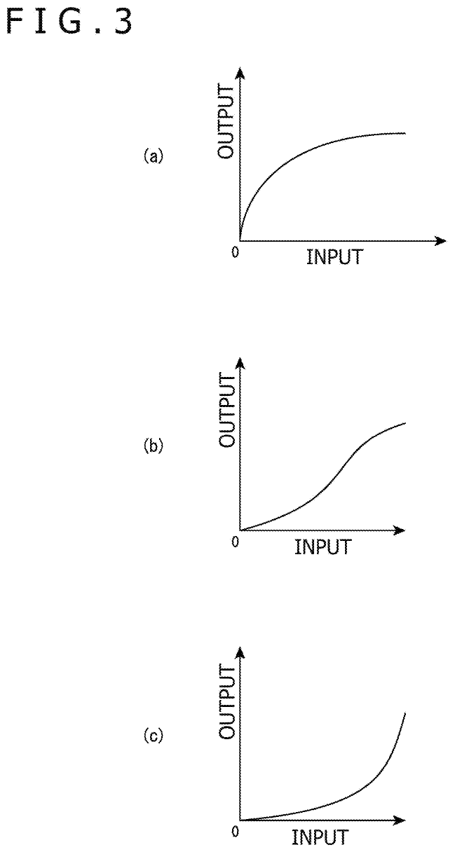

The operation condition storage unit 220 stores the frequency of the pulse light and the gamma curve profile corresponding thereto as operation conditions for the distance image sensor device 10. For example, the operation condition storage unit 220 stores operation conditions corresponding to each of a plurality of preliminarily-set distance measurement ranges (see FIG. 3). The gamma curve profile has, for example, a data structure in the look-up table format. Alternatively, the gamma curve profile may be defined by an approximate curve function.

FIG. 3 includes diagrams each depicting an example of the gamma curve profile in the distance image processing system according to one embodiment of the present technique. In each drawing, the horizontal axis indicates the reach distance of the pulse light, and the vertical axis indicates the calculated distance.

In the drawing, (a) depicts a gamma curve profile corresponding to a distance measurement range for a short distance (for example, approximately 2 m or less). That is, the gamma curve profile depicted in (a) of the drawing depicts that the number of bits allocated to the calculated distance becomes large because the inclination of the curve is larger in an area with a shorter reach distance of the pulse light.

In addition, (b) of the drawing depicts a gamma curve profile corresponding to a distance measurement range for a medium distance (for example, approximately 2 to 5 m). That is, the gamma curve profile depicted in (b) of the drawing depicts that the number of bits allocated to the calculated distance becomes smaller for areas with closer and farther reach distances of the pulse light.

In addition, (c) of the drawing depicts a gamma curve profile corresponding to a distance measurement range for a long distance (for example, approximately 5 m or more). That is, the gamma curve profile depicted in (c) of the drawing depicts that the number of bits allocated to the calculated distance becomes larger for an area with a farther reach distance of the pulse light.

It should be noted that the gamma curve profile is not limited to those exemplified in FIG. 3. For example, the gamma curve profile may be one adjusted by adding, to the conditions of the specified distance measurement range, conditions such as a specific region (for example, giving priority to the center, one of nine divided regions, or the like) of the image frame or giving priority to the autofocus position, or may be one dynamically generated on the basis of a histogram or a distance classification map for the entire screen.

Returning to FIG. 2, the operation condition setting unit 230 is the main or primary component of the operation condition setting unit 111 of the distance image sensor device 10 described above. That is, in order to set desired operation conditions in the distance image sensor device 10, the operation condition setting unit 230 selects and reads one operation condition from the operation condition storage unit 220, and transmits the condition to the distance image sensor device 10. In addition, on the basis of the gamma curve profile of the read operation condition, the operation condition setting unit 230 generates an inverse gamma curve profile, and sets the profile in the inverse gamma correction unit 240. The inverse gamma curve profile is the profile complementarily corresponding to the gamma curve profile. It should be noted that, similarly to the distance image sensor device 10 described above, the operation condition setting unit 230 may store the inverse gamma curve profile in the register and the inverse gamma correction unit 240 may refer to the profile.

The inverse gamma correction unit 240 performs inverse gamma correction on the gamma-corrected distance data transmitted from the distance image sensor device 10 by applying the inverse gamma curve profile. The gamma-corrected distance data from the distance image sensor device 10 is restored to the distance data having the original linearity by the inverse gamma correction. The inverse gamma correction unit 240 delivers the restored distance data to the image processing unit 250.

The image processing unit 250 performs various image processing on the basis of the distance data obtained by the distance image sensor device 10. For example, the image processing unit 250 generates a two-dimensional distance image frame on the basis of the distance image data. The two-dimensional distance image frame has distance (depth) information of, for example, 256 bits per pixel. In addition, the image processing unit 250 generates and outputs display image data so that the depth information of the generated two-dimensional distance image frame is displayed in a visually distinguishable manner on a user interface that is not illustrated.

In the distance image processing system 1 configured as above, the distance image sensor device 10 performs gamma correction on the distance data obtained by distance measurement by applying the gamma curve profile adapted to a predetermined distance measurement range, and transmits the corrected distance data to the host device 20 via the communication line 30. Then, the host device 20 restores the distance data having the original linearity by performing inverse gamma correction on the received gamma-corrected distance data by applying the gamma curve profile.

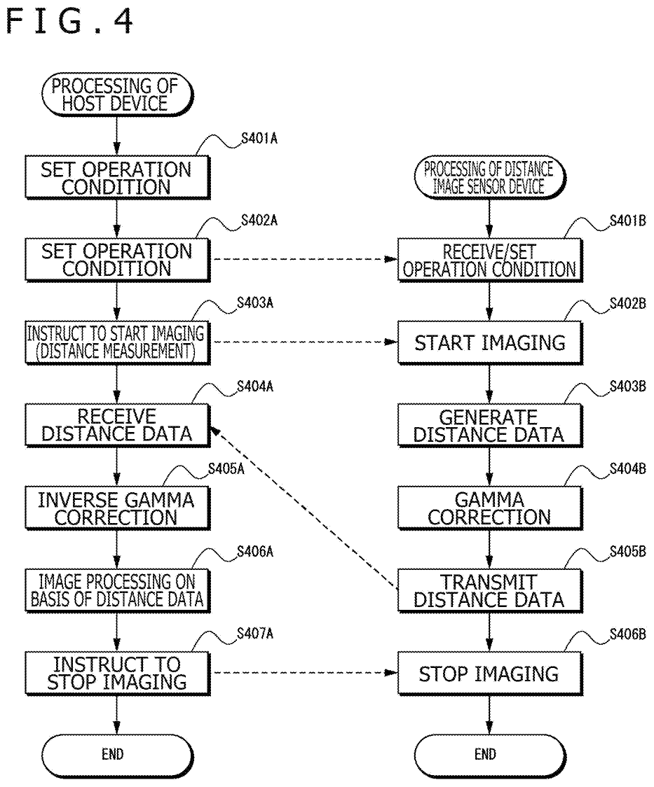

FIG. 4 is a flowchart for explaining an operation in the distance image processing system according to one embodiment of the present invention.

As depicted in the drawing, the host device 20 first selects one operation condition from the operation condition storage unit 220 and sets the condition (S401A). For example, as an application for performing face authentication, the host device 20 selects an operation condition of the distance measurement range for a short distance, generates an inverse gamma curve profile on the basis of the gamma curve profile of the selected operation condition, and sets the generated inverse gamma curve profile in the inverse gamma correction unit 240. Subsequently, the host device 20 transmits the selected operation condition to the distance image sensor device 10 (S402A).

When receiving the operation condition transmitted from the host device 20, the distance image sensor device 10 stores the received operation condition in the register unit 112 (S401B). Accordingly, the distance image sensor device 10 can operate according to the operation condition.

The host device 20 then instructs the distance image sensor device 10 to start imaging (distance measurement) (S403A). In response to this, the distance image sensor device 10 starts imaging according to the operation condition (S402B). That is, according to the set operation condition, the distance image sensor device 10 allows the light emitting unit 120 to emit pulse light with a predetermined frequency toward the target area and also allows each light receiving pixel of the light receiving unit 130 to start receiving incident light from the target area.

Upon the start of imaging, the distance image sensor device 10 generates distance data on the basis of an electric signal obtained from the light receiving unit 130 (S403B). That is, the distance image sensor device 10 creates a histogram for each light receiving pixel on the basis of the electric signal according to the electric charge obtained by each light receiving pixel of the light receiving unit 130, and generates distance data for each light receiving pixel on the basis of the peak value in the created histogram.

Subsequently, the distance image sensor device 10 reads the gamma curve profile stored in the register unit 112, and applies the profile to the generated distance data to perform gamma correction on the distance data (S404B). Accordingly, since the distance data is quantized according to the gamma curve profile, more bits are allocated to the distance corresponding to the desired distance measurement range. Subsequently, the distance image sensor device 10 transmits such gamma-corrected distance data to the host device 20 (S405B).

The host device 20, which has instructed the start of imaging, receives the distance data transmitted from the distance image sensor device 10 (S404A). Subsequently, the host device 20 performs inverse gamma correction on the received distance data by applying an inverse gamma curve profile to the received distance data (S405A). Accordingly, the distance data, which has been gamma-corrected in the distance image sensor device 10 and transmitted on the communication line 30, is restored to the distance data having the original linearity. Subsequently, the host device 20 performs desired image processing on the distance data whose linearity has been restored (S406A).

Then, on the basis of the distance data obtained from the distance image sensor device 10, the host device 20 instructs the distance image sensor device 10 to stop imaging after performing a series of image processing or by an imaging termination instruction from the outside (S407A). In response to this, the distance image sensor device 10 stops imaging (S406B).

As described above, according to the present embodiment, in the distance image processing system 1, the distance image sensor device 10 performs gamma correction on the distance data obtained by distance measurement by applying the gamma curve profile adapted to a predetermined distance measurement range, and transmits the corrected distance data to the host device 20 via the communication line 30, and the host device 20 restores the distance data having the original linearity by performing inverse gamma correction on the received gamma-corrected distance data by applying the gamma curve profile, so that the distance data transmitted on the communication line 30 can be efficiently quantized, thereby improving the data transmission efficiency without significantly deteriorating the image quality.

### Second Embodiment

The present embodiment is characterized in that the distance image sensor device 10 is configured to store a plurality of operation conditions in the register unit 112 in advance and operates by referring to a register corresponding to one operation condition designated by the host device 20.

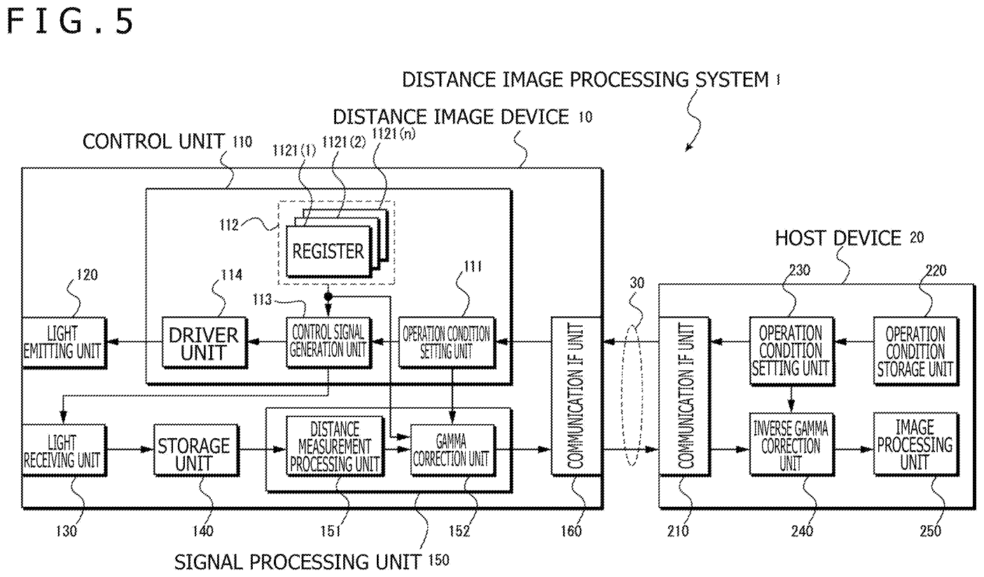

FIG. 5 is a block diagram for depicting an example of a configuration of a distance image processing system according to the second embodiment of the present technique. As depicted in the drawing, the distance image sensor device 10 of the present embodiment is different from that of the first embodiment in that it includes the register unit 112 for storing each of a plurality of operation conditions. In the drawing, the same components as those in the first embodiment are denoted by the same reference signs, and the detailed descriptions thereof are omitted as appropriate. When selecting one operation condition according to the desired distance measurement range, the host device 20 notifies the distance image sensor device 10 of information (for example, the identification information thereof and the like) for designating the selected operation condition, and the distance image sensor device 10 refers, in response to this, to the register unit 112 according to the notified operation condition.

That is, in the drawing, the register unit 112 includes a plurality of registers 1121(1) to 1121(n) (hereafter, these are simply referred to as “register 1121” unless it is necessary to particularly distinguish them from each other). Each of the plurality of registers 1121 stores any of the different operation conditions. Each register 1121 is identified by, for example, an identifier such as a register number. The operation condition may be stored in each of the plurality of registers 1121 in advance (for example, at the time of shipping from the factory or the like), or may be transferred from the host device 20 and stored in each of the plurality of registers 1121.

When an identifier for selecting one operation condition is notified from the host device 20, the operation condition setting unit 111 issues an instruction, to the control signal generation unit 113 and the gamma correction unit 152, to refer to the register 1121 of the register number designated by the identifier. Accordingly, the operation condition is set in the distance image sensor device 10.

The control signal generation unit 113 refers to the register 1121 corresponding to the designated register number, generates, according to the operation condition stored in the register 1121, the light emission control signal, outputs the signal to the driver unit 114, generates the light reception control signal corresponding to the light emission timing, and outputs the signal to the light receiving unit 130 as described above.

The gamma correction unit 152 performs gamma correction on the distance data output from the distance measurement processing unit 151 by referring to the register 1121 corresponding to the designated register number and applying the gamma curve profile stored in the register 1121 as described above. The gamma correction unit 152 outputs the gamma-corrected distance data to the host device 20 via the communication interface unit 160.

The operation condition setting unit 230 of the host device 20 is different from that of the first embodiment in that it notifies the distance image sensor device 10 of an identification number indicating the selected operation condition. As described above, the operation condition setting unit 230 generates the inverse gamma curve profile for the gamma curve profile according to the operation condition read from the operation condition storage unit 220, and sets the profile in the inverse gamma correction unit 240.

As described above, even the present embodiment can exhibit the advantages or effects similar to the above-described embodiment. Among other things, according to the present embodiment, the distance image processing system 1 can operate faster because the host device 20 does not need to transmit entity data of the selected operation condition to the distance image sensor device 10.

### Third Embodiment

The present embodiment is characterized in that the host device 20 transmits a selection condition for selecting the optimal gamma curve profile to the distance image sensor device 10 as an operation condition and that the distance image sensor device 10 selects the optimal frequency of pulse light and the gamma curve profile that satisfy the received operation condition. In addition, the distance image sensor device 10 notifies the host device 20 of the selected gamma curve profile.

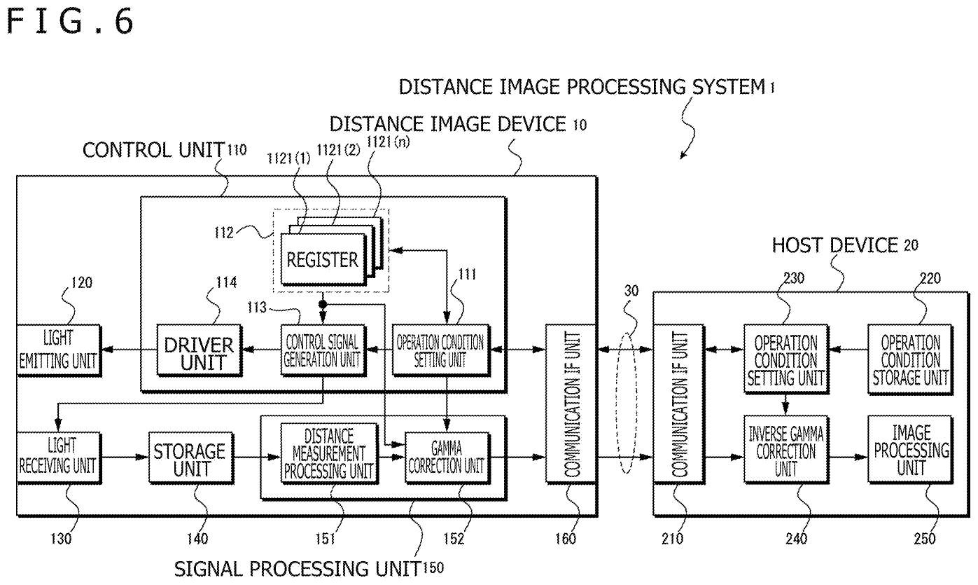

FIG. 6 is a block diagram for depicting an example of a configuration of a distance image processing system according to the third embodiment of the present technique. As depicted in the drawing, the distance image sensor device 10 of the present embodiment is different from those of the above embodiments in that, on the basis of the selection condition (operation condition) received from the host device 20 by the operation condition setting unit 111, the distance image sensor device 10 refers to the register unit 112, selects one gamma curve profile optimum for the received operation condition, and notifies the selected gamma curve profile. In the drawing, the same components as those in the above embodiments are denoted by the same reference signs, and the detailed descriptions thereof are omitted as appropriate.

That is, the operation condition setting unit 230 of the host device 20 transmits an operation condition in which a desired distance measurement range is the selection condition to the distance image sensor device 10 via the communication line 30. In response to this, the operation condition setting unit 111 of the distance image sensor device 10 refers to the register unit 112 to select the frequency of the pulse light and the gamma curve profile adapted to the desired distance measurement range. The operation condition setting unit 111 instructs the control signal generation unit 113 and the gamma correction unit 152 to refer to the register 1121 corresponding to the selected gamma curve profile. Accordingly, the operation condition is set in the distance image sensor device 10. In addition, the operation condition setting unit 111 notifies the host device 20 of the selected gamma curve profile via the communication line 30. For example, if communication complies with the MIPI standard, the distance image sensor device 10 transmits the gamma curve profile to the host device 20 using an essential bit data (EBD) line. In this case, the entity data itself of the selected gamma curve profile may be transmitted, or an identifier indicating the selected gamma curve profile may be transmitted.

On the basis of the gamma curve profile notified from the distance image sensor device 10, the host device 20 refers to the operation condition storage unit 220, generates an inverse gamma curve profile, and sets the profile in the inverse gamma correction unit 240.

It should be noted that, in the present embodiment, the selection condition has been described by using the distance measurement range to be measured as an example, but is not limited to this. For example, the selection condition may include a condition for designating a specific region (for example, giving priority to the center, one of nine divided regions, or the like) of the image frame or giving priority to the autofocus position, instead of or in addition to the condition of the designated distance measurement range. That is, the operation condition setting unit 111 may select a gamma curve profile weighted to emphasize the distance to the object OBJ positioned in the center of the two-dimensional distance image frame according to the selection condition of giving priority to the center of the screen, or the operation condition setting unit 111 may select a gamma curve profile weighted to emphasize the distance to the object OBJ in the autofocus position according to the selection condition of giving priority to the autofocus position. In addition, as will be described in the other embodiments, the selection condition may include a condition that designates interlocking with a histogram or a distance classification map for the entire light receiving pixels.

As described above, even the present embodiment can exhibit the advantages or effects similar to the above-described embodiments. Among other things, according to the present embodiment, since the distance image sensor device 10 selects the optimal gamma curve profile according to the selection condition given from the host device 20, the host device 20 does not need to recognize, in advance, the kinds of gamma curve profiles held by the distance image sensor device 10, and thus the settings in the host device 20 can be simplified.

### Fourth Embodiment

The present embodiment is characterized in that the distance image sensor device 10 is configured to generate a gamma curve profile according to the frequency (or distance measurement range) of pulse light designated by the host device 20. The distance image sensor device 10 transmits the generated gamma curve profile to the host device 20, and the host device 20 generates and sets an inverse gamma curve profile on the basis of the received gamma curve profile.

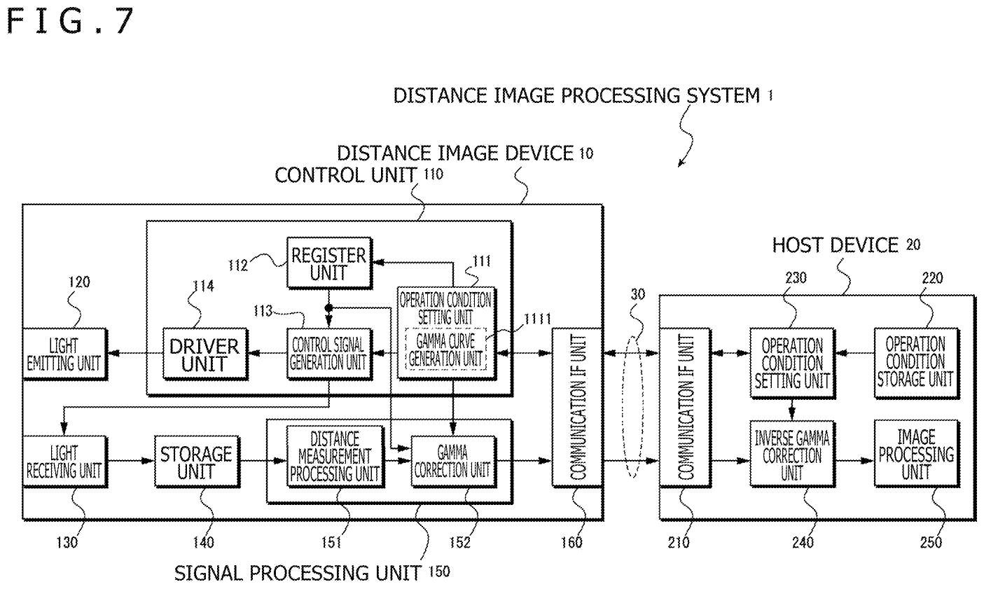

FIG. 7 is a block diagram for depicting an example of a configuration of a distance image processing system according to the fourth embodiment of the present technique. As depicted in the drawing, the distance image sensor device 10 of the present embodiment is different from those of the above embodiments in that the operation condition setting unit 111 includes a gamma curve generation unit 1111, generates the optimal gamma curve profile on the basis of the operation condition received from the host device 20, and writes the profile to the register unit 112. In the drawing, the same components as those in the above embodiments are denoted by the same reference signs, and the detailed descriptions thereof are omitted as appropriate.

That is, the operation condition setting unit 230 of the host device 20 transmits the operation condition (information designating the distance measurement range) designating the desired distance measurement range to the distance image sensor device 10 via the communication line 30. The information designating the distance measurement range can be the distance measurement range itself or the frequency of pulse light. In response to this, the operation condition setting unit 111 of the distance image sensor device 10 allows the gamma curve generation unit 11111 to generate a gamma curve profile according to the designated distance measurement range, and stores the profile in the register unit 112 together with the frequency of pulse light adapted to the distance measurement range. Accordingly, the operation condition is set in the distance image sensor device 10. In addition, the operation condition setting unit 111 notifies the host device 20 of the selected gamma curve profile via the communication line 30. The operation condition setting unit 111 may transmit or deliver the entity data itself of the selected gamma curve profile.

On the basis of the gamma curve profile notified from the distance image sensor device 10, the host device 20 refers to the operation condition storage unit 220, generates an inverse gamma curve profile, and sets the profile in the inverse gamma correction unit 240.

As described above, even the present embodiment can exhibit the advantages or effects similar to the above-described embodiments. Among other things, according to the present embodiment, since the distance image sensor device 10 generates the optimal gamma curve profile according to the operation condition given from the host device 20, the host device 20 does not need to recognize, in advance, the kinds of gamma curve profiles held by the distance image sensor device 10, and thus the settings in the host device 20 can be simplified.

### Fifth Embodiment

The present embodiment is characterized in that the distance image sensor device 10 optimizes a gamma curve profile on the basis of a histogram for the entire light receiving pixels obtained by imaging (distance measurement). The distance image sensor device 10 transmits the optimized gamma curve profile to the host device 20, and the host device 20 generates and sets an inverse gamma curve profile on the basis of the received gamma curve profile.

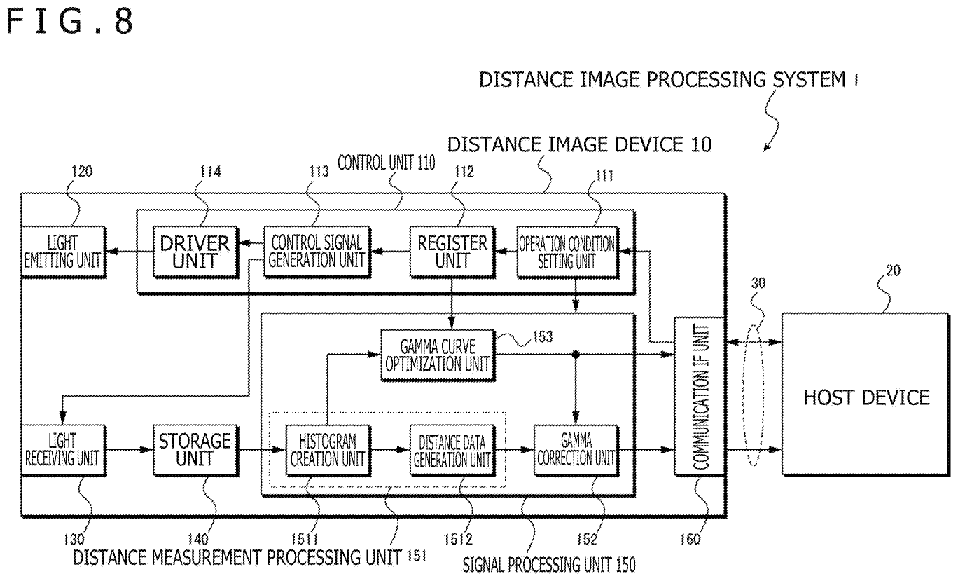

FIG. 8 is a block diagram for depicting an example of a configuration of a distance image processing system according to the fifth embodiment of the present technique. As depicted in the drawing, the distance image sensor device 10 of the present embodiment is different from those of the above embodiments in that the signal processing unit 150 additionally includes a gamma curve optimization unit 153. It should be noted that, in the drawing, the functional configuration of the host device 20 is omitted because it is the same as the above embodiments. In addition, in the drawing, the same components as those in the above embodiments are denoted by the same reference signs, and the detailed descriptions thereof are omitted as appropriate.

That is, the host device 20 transmits the desired operation condition to the distance image sensor device 10 via the communication line 30. Here, it is assumed that the desired operation condition includes the frequency of pulse light and the gamma curve profile. In response to this, the operation condition setting unit 111 of the distance image sensor device 10 stores the received operation condition in the register unit 112. Accordingly, the distance image sensor device 10 operates according to the set operation condition.

As described above, upon the start of imaging, the light receiving unit 130 temporarily stores, in the storage unit 140, the electric signal according to the electric charge obtained by the light receiving pixels. The distance measurement processing unit 151 calculates the distance for each light receiving pixel from the electric signal read from the storage unit 140 and creates the histogram thereof. Subsequently, the distance measurement processing unit 151 detects the peak value of each created histogram and generates distance data on the basis of the detected peak value. Then, the distance measurement processing unit 151 outputs a series of distance data calculated for each light receiving pixel to the gamma correction unit 152.

More specifically, the distance measurement processing unit 151 includes a histogram creation unit 1511 and a distance data generation unit 1512 as depicted in the drawing. Each time the emission pulse is emitted by the light emitting unit 120, the histogram creation unit 1511 calculates the distance for each light receiving pixel from the electric signal read from the storage unit 140, and creates a histogram as depicted in FIG. 9 in which the distance is accumulated for each sampling distance (bin). Subsequently, the distance data generation unit 1512 detects the peak value in each created histogram, determines the distance for the light receiving pixel on the basis of the detected peak value, and generates the distance data thereof.

In addition, in the present embodiment, the gamma curve optimization unit 153 identifies the most frequent distance range on the basis of the histogram created by the histogram creation unit 1511. Subsequently, the gamma curve optimization unit 153 adjusts or optimizes the gamma curve profile so that more bits are allocated to the identified distance range. In the example of the histogram depicted in FIG. 9, the gamma curve optimization unit 153 adjusts the gamma curve profile so that more bits are allocated to a distance range of 4 m or more and less than 7 m (the range enclosed by the dashed line in the drawing). Specifically, the gamma curve optimization unit 153 adjusts the gamma curve profile so that, for example, one bit is allocated per 0.1 mm to a distance range of 4 m or more and less than 7 m, and, for example, one bit is allocated per 1 mm to the other distance ranges. The gamma curve optimization unit 153 transmits the optimized gamma curve profile to the host device 20 and sets the profile in the gamma correction unit 152. Accordingly, the operation condition setting unit 230 of the host device 20 generates an inverse gamma curve profile on the basis of the received optimized gamma curve profile and sets the profile in the inverse gamma correction unit 240.

The gamma correction unit 152 performs gamma correction on the distance data output from the distance measurement processing unit 151 by applying the gamma curve profile optimized by the gamma curve optimization unit 153. That is, the distance data having linearity is converted into quantized data (gamma-corrected distance data) according to the gamma curve profile by the gamma correction. The gamma correction unit 152 outputs the gamma-corrected distance data to the host device 20 via the communication interface unit 160.

The host device 20, which has received the gamma-corrected distance data, performs inverse gamma correction on the gamma-corrected distance data by applying an inverse gamma curve profile. The gamma-corrected distance data from the distance image sensor device 10 is restored to the distance data having the original linearity by the inverse gamma correction. The inverse gamma correction unit 240 delivers the restored distance data to the image processing unit 250.

In the present embodiment, the example in which the histogram is used to optimize the gamma curve profile has been described, but, for example, a distance classification map may be used.

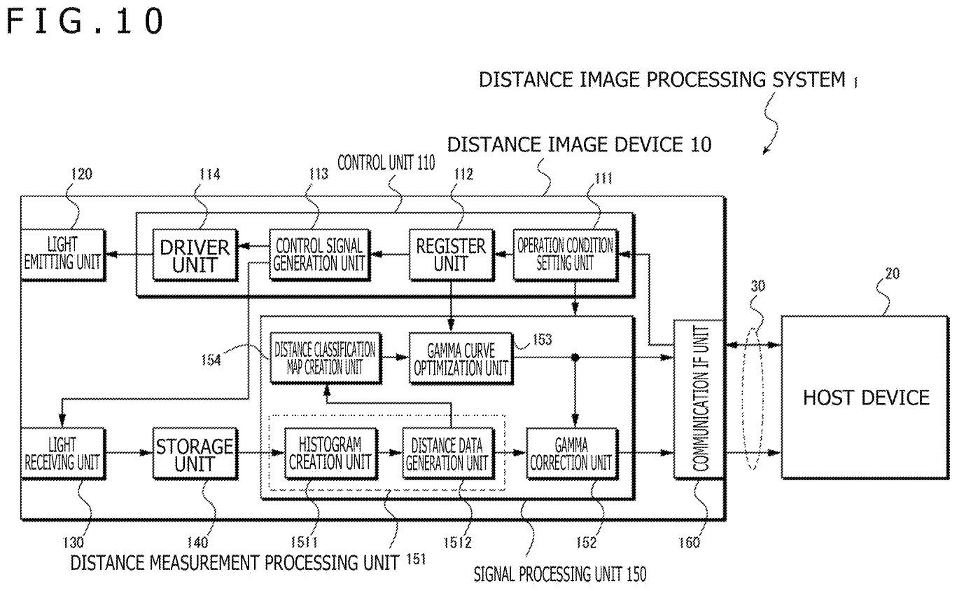

FIG. 10 is a block diagram for depicting a different example of a configuration of a distance image processing system according to the fifth embodiment of the present technique. As depicted in the drawing, the distance image sensor device 10 of the present embodiment is different from that depicted in FIG. 8 in that it further includes a distance classification map creation unit 154. It should be noted that, in the drawing, the same components as those in the above embodiments are denoted by the same reference signs, and the detailed descriptions thereof are omitted as appropriate.

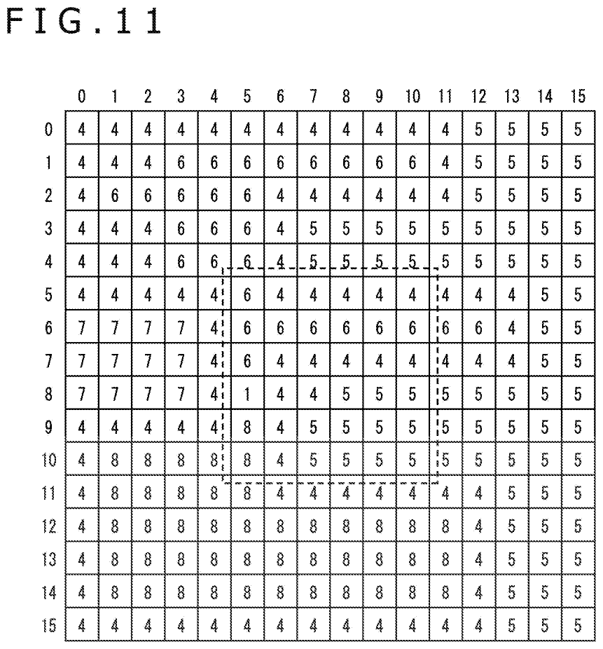

The distance classification map creation unit 154 creates a distance classification map on the basis of the distance data generated by the distance data generation unit 1512. The distance classification map is a map in which, if the distances calculated between adjacent groups of light receiving pixels are close to each other, the distances for those groups of light receiving pixels are classified as the same distance (for example, numerical values normalized to a scale of 1 to 10). FIG. 11 is a diagram for explaining an example of the distance classification map in the distance image processing system according to one embodiment of the present technique. The distance classification map can correspond to a two-dimensional distance image frame.

The gamma curve optimization unit 153 identifies, for example, the most frequent distance on the basis of the distance classification map created by the distance classification map creation unit 154. In the example depicted in FIG. 11, the gamma curve optimization unit 153 identifies the distance indicated by scale 4 as the most frequent distance for the group of light receiving elements indicated in the dashed frame. Subsequently, the gamma curve optimization unit 153 adjusts or optimizes the gamma curve profile so that more bits are allocated to the identified distance. As another example, the gamma curve optimization unit 153 may identify the most frequent distance in the central region of the distance classification map and may adjust or optimize the gamma curve profile so that more bits are allocated to the identified distance. As yet another example, the gamma curve optimization unit 153 may adjust or optimize the gamma curve profile so that more bits are allocated to the distance matching the autofocus position. The gamma curve optimization unit 153 transmits the adjusted or optimized gamma curve profile to the host device 20 via the communication interface unit 160.

As described above, even the present embodiment can exhibit the advantages or effects similar to the above-described embodiments. Among other things, according to the present embodiment, the gamma curve profile adapted to the distance measurement range is further dynamically optimized on the basis of the histogram or the distance classification map created during the distance measurement, and thus data transmission can be performed more efficiently without significantly deteriorating the image quality.

Each of the above embodiments is illustrative to explain the present invention, and the present invention is not intended to be limited to these embodiments only. The present invention can be carried out in various forms as long as it does not deviate from the scope thereof.

For example, in the methods disclosed in the specification, the steps, actions, or functions may be carried out in parallel or in a different order as long as the results are not inconsistent. The described steps, actions, and functions are merely provided as examples, and some of the steps, actions, and functions can be omitted in the range without deviating from the scope of the invention, and may be one by being combined with each other, and other steps, actions, or functions may be added.

In addition, although various embodiments are disclosed in the specification, specific features (technical matters) in one embodiment can be added to or replaced with specific features in the other embodiments while appropriately making an improvement, and such forms are also included in the scope of the present invention.

The present technology may also have the following configurations.
(1)
   A distance image sensor device including:
   an operation condition setting unit for setting operation conditions including a frequency and a gamma curve profile adapted to a predetermined distance measurement range;
   a light emitting unit that emits pulse light to a target area at the frequency under the set operation conditions;
   a light receiving unit that includes a plurality of light receiving pixels for receiving observation light in the target area in response to the pulse light and each outputting an electric signal according to an electric charge accumulated by photoelectric conversion;
   a distance measurement processing unit that calculates a distance to an object in the target area on the basis of the electric signal output from each of the plurality of light receiving pixels and outputs distance data based on the distance;
   a gamma correction unit that performs gamma correction on the output distance data by applying the gamma curve profile in the set operation conditions; and
   a communication interface unit that transmits the gamma-corrected distance data to a host device.
(2)
   The distance image sensor device according to the above configuration, further including:
   a register unit that is able to store the operation conditions.
(3)
   The distance image sensor device according to any one of the above configurations,
   in which the operation condition setting unit stores the operation conditions received from the host device via the communication interface unit in the register unit.
(4)
   The distance image sensor device according to any one of the above configurations,
   in which the register unit includes a plurality of registers that can store each of a plurality of the operation conditions, and
   in which the operation condition setting unit sets one of the operation conditions by designating any of the plurality of registers according to information for designating the operation conditions received from the host device via the communication interface unit.
(5)
   The distance image sensor device according to any one of the above configurations,
   in which the operation condition setting unit selects the one of the plurality of operation conditions according to a selection condition received from the host device via the communication interface unit.
(6)
   The distance image sensor device according to any one of the above configurations,
   in which the selection condition includes a condition for designating a specific region and an autofocus position of an image frame.
(7)
   The distance image sensor device according to any one of the above configurations,
   in which the operation condition setting unit notifies the host device of the gamma curve profile of the selected one of the operation conditions via the communication interface unit.
(8)
   The distance image sensor device according to any one of the above configurations,
   in which the operation condition setting unit
      generates the gamma curve profile on the basis of information for designating the predetermined distance measurement range received from the host device via the communication interface unit and sets the operation conditions according to the generated gamma curve profile, and
      notifies the host device of the generated gamma curve profile via the communication interface unit.
(9)
   The distance image sensor device according to any one of the above configurations, further including:
   a gamma curve optimization unit that optimizes the gamma curve profile in the set operation condition,
   in which the gamma correction unit performs the gamma correction on the output distance data by applying the optimized gamma curve profile.
(10)
   The distance image sensor device according to any one of the above configurations, further including:
   a histogram creation unit that creates a histogram based on the distance calculated for each of the plurality of light receiving pixels on the basis of the electric signal,
   in which the gamma curve optimization unit optimizes the gamma curve profile on the basis of the created histogram.
(11)
   The distance image sensor device according to any one of the above configurations,
   in which the gamma curve optimization unit optimizes the gamma curve profile according to the most frequent distance range in the created histogram.
(12)
   The distance image sensor device according to any one of the above configurations, further including:
   a distance classification map creation unit that creates a distance classification map based on the distance for each group of the adjacent light receiving pixels on the basis of the output distance data,
   in which the gamma curve optimization unit optimizes the gamma curve profile in the operation condition on the basis of the created distance classification map.
(13)
   The distance image sensor device according to any one of the above configurations,
   in which the gamma curve optimization unit optimizes the gamma curve profile according to the most frequent distance in the created distance classification map.
(14)
   The distance image sensor device according to any one of the above configurations,
   in which the gamma curve optimization unit transmits the optimized gamma curve profile to the host device via the communication interface unit.
(15)
   The distance image sensor device according to any one of the above configurations, further including:
   a control signal generation unit that generates a light emission control signal for emitting the pulse light at a predetermined frequency,
   in which the control signal generation unit generates the light emission control signal according to the operation conditions stored in the register unit.
(16)
   A distance image processing system including:
   a distance image device; and
   a host device connected to the distance image device via a communication line,
   in which the distance image device includes
      an operation condition setting unit for setting operation conditions including a frequency and a gamma curve profile adapted to a predetermined distance measurement range,
      a light emitting unit that emits pulse light to a target area at the frequency under the set operation conditions,
      a light receiving unit that includes a plurality of light receiving pixels for receiving observation light in the target area in response to the pulse light and each outputting an electric signal according to an electric charge accumulated by photoelectric conversion,
      a distance measurement processing unit that calculates a distance to an object in the target area on the basis of the electric signal output from each of the plurality of light receiving pixels and outputs distance data based on the distance,
      a gamma correction unit that performs gamma correction on the output distance data by applying the gamma curve profile in the set operation conditions, and
      a communication interface unit that transmits the gamma-corrected distance data to a host device via the communication line, and
   in which the host device includes a gamma correction unit that performs inverse gamma correction on the distance data received via the communication line by applying an inverse gamma curve profile corresponding to the gamma curve profile in the operation conditions.
(17)
   The distance image processing system according to the above configuration,
   in which the host device transmits operation conditions adapted to the predetermined distance measurement range to the distance image device via the communication line.
(18)
   The distance image processing system according to any one of the above configurations,
   in which the host device generates the inverse gamma curve profile on the basis of the gamma curve profile in the operation conditions.
(19)
   The distance image processing system according to any one of the above configurations,
   in which the host device generates the inverse gamma curve profile on the basis of the gamma curve profile transmitted from the distance image device.
(20)
   A transmission method of distance data between a distance image device and a host device in a distance image processing system, the method comprising:
   by distance image device,
   setting operation conditions including a frequency and a gamma curve profile adapted to a predetermined distance measurement range;
   emitting pulse light to a target area at the frequency under the set operation conditions;
   receiving observation light in the target area in response to the pulse light and outputting an electric signal according to an electric charge accumulated by photoelectric conversion from each of a plurality of light receiving pixels;
   calculating a distance to an object in the target area on the basis of the electric signal output from each of the plurality of light receiving pixels and outputting distance data based on the distance;
   performing gamma correction on the output distance data by applying the gamma curve profile in the set operation conditions; and
   transmitting the gamma-corrected distance data to the host device via a communication line.

### REFERENCE SIGNS LIST

1: Distance image processing system
10: Distance image sensor device
110: Control unit
111: Operation condition setting unit
112: Register unit
1121: Register
113: Control signal generation unit
114: Driver unit
120: Light emitting unit
130: Light receiving unit
140: Storage unit
150: Signal processing unit
151: Distance measurement processing unit
1511: Histogram creation unit
1512: Distance data generation unit
152: Gamma correction unit
153: Gamma curve optimization unit
154: Distance classification map creation unit
160: Communication interface unit
20: Host device
210: Communication interface unit
220: Operation condition storage unit
230: Operation condition setting unit
240: Inverse gamma correction unit
250: Image processing unit
30: Communication line

1. A distance image sensor device comprising:
an operation condition setting unit for setting operation conditions including a frequency and a gamma curve profile adapted to a predetermined distance measurement range;
a light emitting unit that emits pulse light to a target area at the frequency under the set operation conditions;
a light receiving unit that includes a plurality of light receiving pixels for receiving observation light in the target area in response to the pulse light and each outputting an electric signal according to an electric charge accumulated by photoelectric conversion;
a distance measurement processing unit that calculates a distance to an object in the target area on a basis of the electric signal output from each of the plurality of light receiving pixels and outputs distance data based on the distance;
a gamma correction unit that performs gamma correction on the output distance data by applying the gamma curve profile in the set operation conditions; and
a communication interface unit that transmits the gamma-corrected distance data to a host device.

2. The distance image sensor device according to claim 1, further comprising:
a register unit that is able to store the operation conditions.

3. The distance image sensor device according to claim 2,
wherein the operation condition setting unit stores the operation conditions received from the host device via the communication interface unit in the register unit.

4. The distance image sensor device according to claim 2,
wherein the register unit includes a plurality of registers that is able to store each of a plurality of the operation conditions, and
wherein the operation condition setting unit sets one of the operation conditions by designating any of the plurality of registers according to information for designating the operation conditions received from the host device via the communication interface unit.

5. The distance image sensor device according to claim 4,
wherein the operation condition setting unit selects the one of the plurality of operation conditions according to a selection condition received from the host device via the communication interface unit.

6. The distance image sensor device according to claim 5,
wherein the selection condition includes a condition for designating a specific region and an autofocus position of an image frame.

7. The distance image sensor device according to claim 5,
wherein the operation condition setting unit notifies the host device of the gamma curve profile of the selected one of the operation conditions via the communication interface unit.

8. The distance image sensor device according to claim 1,
wherein the operation condition setting unit
generates the gamma curve profile on a basis of information for designating the predetermined distance measurement range received from the host device via the communication interface unit and sets the operation conditions according to the generated gamma curve profile, and
notifies the host device of the generated gamma curve profile via the communication interface unit.

9. The distance image sensor device according to claim 1, further comprising:
a gamma curve optimization unit that optimizes the gamma curve profile in the set operation condition,
wherein the gamma correction unit performs the gamma correction on the output distance data by applying the optimized gamma curve profile.

10. The distance image sensor device according to claim 9, further comprising:
a histogram creation unit that creates a histogram based on the distance calculated for each of the plurality of light receiving pixels on a basis of the electric signal,
wherein the gamma curve optimization unit optimizes the gamma curve profile on a basis of the created histogram.

11. The distance image sensor device according to claim 10,
wherein the gamma curve optimization unit optimizes the gamma curve profile according to a most frequent distance range in the created histogram.

12. The distance image sensor device according to claim 9, further comprising:
a distance classification map creation unit that creates a distance classification map based on the distance for each group of the adjacent light receiving pixels on a basis of the output distance data,
wherein the gamma curve optimization unit optimizes the gamma curve profile in the operation condition on a basis of the created distance classification map.

13. The distance image sensor device according to claim 12,
wherein the gamma curve optimization unit optimizes the gamma curve profile according to a most frequent distance in the created distance classification map.

14. The distance image sensor device according to claim 9,
wherein the gamma curve optimization unit transmits the optimized gamma curve profile to the host device via the communication interface unit.

15. The distance image sensor device according to claim 2, further comprising:
a control signal generation unit that generates a light emission control signal for emitting the pulse light at a predetermined frequency,
wherein the control signal generation unit generates the light emission control signal according to the operation conditions stored in the register unit.

16. A distance image processing system comprising:
a distance image device; and
a host device connected to the distance image device via a communication line,
wherein the distance image device includes
an operation condition setting unit for setting operation conditions including a frequency and a gamma curve profile adapted to a predetermined distance measurement range,
a light emitting unit that emits pulse light to a target area at the frequency under the set operation conditions,
a light receiving unit that includes a plurality of light receiving pixels for receiving observation light in the target area in response to the pulse light and each outputting an electric signal according to an electric charge accumulated by photoelectric conversion,
a distance measurement processing unit that calculates a distance to an object in the target area on a basis of the electric signal output from each of the plurality of light receiving pixels and outputs distance data based on the distance,
a gamma correction unit that performs gamma correction on the output distance data by applying the gamma curve profile in the set operation conditions, and
a communication interface unit that transmits the gamma-corrected distance data to a host device via the communication line, and
wherein the host device includes a gamma correction unit that performs inverse gamma correction on the distance data received via the communication line by applying an inverse gamma curve profile corresponding to the gamma curve profile in the operation conditions.

17. The distance image processing system according to claim 16,
wherein the host device transmits operation conditions adapted to the predetermined distance measurement range to the distance image device via the communication line.

18. The distance image processing system according to claim 16,
wherein the host device generates the inverse gamma curve profile on a basis of the gamma curve profile in the operation conditions.

19. The distance image processing system according to claim 16,
wherein the host device generates the inverse gamma curve profile on a basis of the gamma curve profile transmitted from the distance image device.

20. A transmission method of distance data between a distance image device and a host device in a distance image processing system, the method comprising:
by distance image device,
setting operation conditions including a frequency and a gamma curve profile adapted to a predetermined distance measurement range;
emitting pulse light to a target area at the frequency under the set operation conditions;
receiving observation light in the target area in response to the pulse light and outputting an electric signal according to an electric charge accumulated by photoelectric conversion from each of a plurality of light receiving pixels;
calculating a distance to an object in the target area on a basis of the electric signal output from each of the plurality of light receiving pixels and outputting distance data based on the distance;
performing gamma correction on the output distance data by applying the gamma curve profile in the set operation conditions; and
transmitting the gamma-corrected distance data to the host device via a communication line.
